(19) United States
(12) Patent Application Publication
(10) Pub. No.: US 2026/0246202 A1
(43) Pub. Date: Aug. 20, 2026

(54) SEMICONDUCTOR DEVICE

(71) Applicant: Micron Technology, Inc., Boise, ID (US)

(72) Inventor: Kazuyuki Morishige, Sagamihara-shi (JP)

(73) Assignee: Micron Technology, Inc., Boise, ID (US)

(21) Appl. No.: 19/537,370

(22) Filed: Feb. 11, 2026

Related U.S. Application Data
(60) Provisional application No. 63/759,727, filed on Feb. 18, 2025.

(51) Int. Cl. H01R 13/6467; G06F 1/10; H01R 12/71; H01R 13/514; H01R 24/60; H01R 24/64

(52) U.S. Cl. CPC H01R 13/6467; G06F 1/10; H01R 12/716; H01R 13/514; H01R 24/60; H01R 24/64

(57) ABSTRACT

An apparatus includes: a first wiring in one of lower and upper wiring layers; a second wiring in the other of the lower and upper wiring layers, the second wiring extending in parallel to the first wiring; a plurality of contact plugs coupled between the first wiring and the second wiring and arranged in line along the first wiring and the second wiring; and a third wiring in the one of the lower and upper wiring layers, the third wiring being branched into a plurality of wiring segments which are directly coupled to the first wiring.

### CROSS-REFERENCE TO RELATED APPLICATIONS

This application claims the filing benefit of U.S. Provisional Application No. 63/759,727, filed February 18, 2025. This application is incorporated by reference herein in its entirety and for all purposes.

### BACKGROUND

With respect to semiconductor devices exemplified by dynamic random access memory (DRAM), the operating speed is increasing, and enhancement in integration is progressing by miniaturization of electronic circuits. In order to miniaturize the electronic circuits, it is necessary to reduce the widths of wirings and diameters of contact plugs in the semiconductor devices. On the other hand, as the operating speed increases more greatly, current concentration may occur due to wiring patterns in wirings that carry a large amount of current, such as clock signal wirings, so that the amount of current may increase locally. In areas where the amount of the current is large, electromigration may occur in wirings and contact plugs.

### BRIEF DESCRIPTION OF THE DRAWINGS

FIG. 1 is a layout diagram showing a schematic configuration of a semiconductor device according to a first embodiment;

FIG. 2 is a perspective view showing a schematic configuration of a part of the semiconductor device according to the first embodiment;

FIG. 3 is a layout diagram showing a schematic configuration of a semiconductor device according to a second embodiment;

FIG. 4 is a layout diagram showing a schematic configuration of a semiconductor device according to a third embodiment; and

FIG. 5 is a diagram showing a schematic configuration of a semiconductor device according to an embodiment.

### DETAILED DESCRIPTION

Various embodiments of the present disclosure will be explained below in detail with reference to the accompanying drawings. The following detailed description refers to the accompanying drawings that show, by way of illustration, specific aspects, and various embodiments of the present disclosure. The detailed description provides sufficient detail to enable those skilled in the art to practice these embodiments of the present disclosure. Other embodiments may be utilized, and structural, logical, and electrical changes may be made without departing from the scope of the present disclosure. The various embodiments disclosed herein are not necessarily mutually exclusive, as some disclosed embodiments can be combined with one or more other disclosed embodiments to form new embodiments.

Semiconductor devices according to embodiments will be described below with reference to the drawings. In the following description, a distribution path of a signal generated by a circuit that generates a clock signal and is arranged in a peripheral circuit of a DRAM will be described as an example. In the description of the embodiments, common or related elements, or substantially identical elements, are given the same reference signs, and descriptions thereof will be omitted. In the following drawings, the dimensions and dimensional ratios of the respective parts in the respective drawings may not necessarily match the dimensions and dimensional ratios in the embodiments.

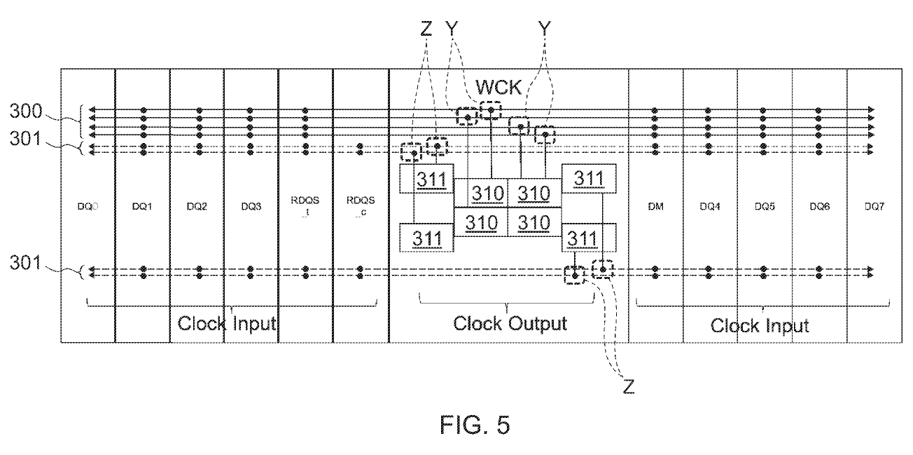

FIG. 5 is a diagram showing an application example of semiconductor devices according to first, second, and third embodiments described below. FIG. 5 is a diagram showing the configuration of a part of a peripheral circuit that controls memory cells of a DRAM, which is exemplified as a semiconductor device according to the embodiments. Here, as an example, the configuration of a peripheral circuit of a low power double data rate (LPDDR) synchronous dynamic random access memory (SDRAM) is shown.

As shown in FIG. 5, a semiconductor device 100 includes a clock output unit WCK, and two clock input units (Clock Input) arranged so as to interpose the clock output unit therebetween. For example, four write clock drivers 310 and four read clock drivers 311 are arranged in the clock output unit WCK. Data transfer signal supply circuits DQ0 to DQ7, read clock signal supply circuits RDQS_t and RDQS_c, and a data mask signal supply circuit DM are arranged in the clock input unit.

Write clock signal trunk lines 300 and read clock signal trunk lines 301 include a plurality of signal lines for transmitting clock signals. Each write clock driver 310 and a write clock signal trunk line 300 corresponding thereto are connected to each other at a connection portion Y via a wiring. Each read clock driver 311 and a read clock signal trunk line 301 corresponding thereto are connected to each other at a connection portion Z via a wiring. At the connection portions Y and Z, current concentration may occur during transmission or reception of signals between the clock signal trunk lines 300, 301 and the clock drivers 310, 311, which may increase the current locally.

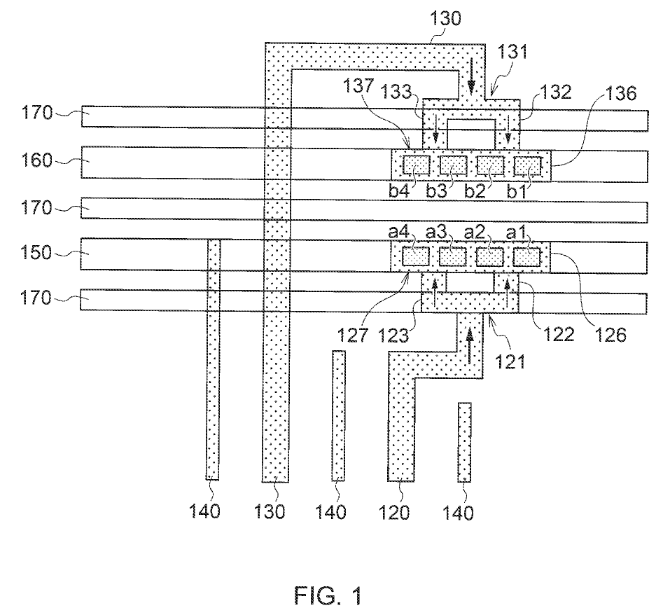

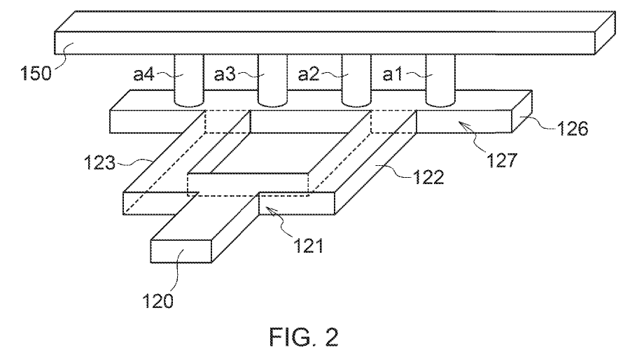

FIG. 1 is a diagram showing a schematic configuration of a semiconductor device according to a first embodiment, and is a layout diagram showing an example of a schematic configuration of wiring connection at the connection portion Y or Z shown in FIG. 5. FIG. 2 is a partial perspective view showing an example of the schematic configuration of the wiring connection at the connection portion Y or Z, and shows an example of a schematic configuration of a connection portion between a first clock driver signal line 120 and a first clock signal trunk line 150 in FIG. 1.

The first clock driver signal line 120, the second clock driver signal line 130 corresponds to a wiring that connects the clock driver 310 or 311 to the clock signal trunk line 300 or 301. The first clock signal trunk line 150 and the second clock signal trunk line 160 correspond to either the clock signal trunk line 300 or 301. Shields 140 and 170 are provided to restrain signal coupling between adjacent clock driver signal lines 120 and 130 and adjacent clock signal trunk lines 150 and 160.

The first clock driver signal line 120 and the second clock driver signal line 130 are included in conductive wirings of a first layer. The first clock signal trunk line 150 and the second clock signal trunk line 160 are included in conductive wirings of a second layer which is a layer different from the first layer. Here, as shown in FIG. 2, the first layer to which the first clock driver signal line 120 belongs is disposed below the second layer to which the first clock signal trunk line 150 belongs.

The first clock driver signal line 120 branches into two wiring segments 122 and 123 at a branching portion 121. The wiring segments 122 and 123 are each connected to a connection wiring 126. The wiring segments 122 and 123 and the connection wiring 126 are included in the first layer. The connection wiring 126 is connected to the first clock signal trunk line 150 via contact plugs a1, a2, a3, and a4. Here, the connection wiring 126 and the first clock signal trunk line 150 are connected to each other by the four contact plugs a1, a2, a3, and a4. The four contact plugs a1, a2, a3, and a4 are divided into groups such that the numbers of contact plugs of the respective groups are the same. Here, the contact plugs a1, a2, a3, and a4 are divided into two groups each including two contact plugs, that is, a first group including the contact plugs a1 and a2, and a second group including the contact plugs a3 and a4.

The connection wiring 126 is an island-shaped local wiring with its longitudinal direction aligned with an extension direction of the first clock signal trunk line 150. The same is true for a connection wiring 226 described later. The contact plugs a1, a2, a3, and a4 are arranged in order along the extension direction of the first clock signal trunk line 150 and the connection wiring 126. The contact plugs a1, a2, a3, and a4 are arranged at equal intervals.

The wiring segments 122 and 123 are connected to the connection wiring 126 such that current flows uniformly from the first clock driver signal line 120 into the contact plugs a1, a2, a3, and a4. Here, the wiring segments 122 and 123 are connected to the connection wiring 126 at a portion between the adjacent contact plugs a1 and a2 and at a portion between the adjacent contact plugs a3 and a4, respectively. In other words, the wiring segment 122 is associated with the first group, and is connected to the connection wiring 126 at the portion between the contact plugs a1 and a2, which is located at the center of the first group. The wiring segment 123 is associated with the second group, and is connected to the connection wiring 126 at the portion between the contact plugs a3 and a4, which is located at the center of the second group.

The second clock driver signal line 130 branches into two wiring segments 132 and 133 at a branching portion 131. Each of the wiring segments 132 and 133 is connected to a connection wiring 136. The second clock driver signal line 130, the wiring segments 132 and 133, and the connection wiring 136 are included in the first layer. The connection wiring 136 is connected to the second clock signal trunk line 160 via contact plugs b1, b2, b3, and b4. Here, the connection wiring 136 and the second clock signal trunk line 160 are directly connected to each other by the four contact plugs b1, b2, b3, and b4. The four contact plugs b1, b2, b3, and b4 are divided into groups such that the numbers of contact plugs of the respective groups are the same. Here, the contact plugs b1, b2, b3 and b4 are divided into groups each including two contact plugs, that is, a third group including the contact plugs b1 and b2, and a fourth group including the contact plugs b3 and b4.

The connection wiring 136 is an island-shaped local wiring with its longitudinal direction aligned with the extension direction of the second clock signal trunk line 160. The same is true for a connection wiring 236 described later. The contact plugs b1, b2, b3, and b4 are arranged in order along the extension direction of the second clock signal trunk line 160 and the connection wiring 136. The contact plugs b1, b2, b3, and b4 are arranged at equal intervals.

The wiring segments 132 and 133 are connected to the connection wiring 136 such that current flows uniformly from the second clock driver signal line 130 into the contact plugs b1, b2, b3, and b4. Here, the wiring segments 132 and 133 are connected to the connection wiring 136 at a portion between the adjacent contact plugs b1 and b2 and at a portion between the adjacent contact plugs b3 and b4, respectively. In other words, the wiring segment 132 is associated with the third group, and is connected to the connection wiring 136 at the portion between the contact plugs b1 and b2, which is located in the center of the third group. The wiring segment 133 is associated with the fourth group, and is connected to the connection wiring 136 at the portion between the contact plugs b3 and b4, which is located in the center of the fourth group.

The first clock driver signal line 120, the second clock driver signal line 130, the first clock signal trunk line 150, and the second clock signal trunk line 160, the contact plugs a1, a2, a3, and a4, and the contact plugs b1, b2, b3, and b4 include a conductive material, and for example, include a metal such as tungsten (W), copper (Cu), or titanium nitride (TiN), or a metal compound thereof.

As described above, the first clock driver signal line 120 branches into the wiring segments 122 and 123, and the branched wiring segments 122 and 123 are further connected to the connection wiring 126 while uniformly dispersed in the manner described above. As a result, the current flowing from the first clock driver signal line 120 is dispersively distributed to the contact plugs a1, a2, a3, and a4, so that the current is restrained from concentrating on a specific contact plug, thereby restraining electromigration in the contact plugs a1, a2, a3, and a4.

Similarly, the second clock driver signal line 130 branches into the wiring segments 132 and 133, and the branched wiring segments 132 and 133 are further connected to the connection wiring 136 while uniformly dispersed in the manner described above. As a result, the current flowing from the second clock driver signal line 130 is dispersively distributed to the contact plugs b1, b2, b3, and b4, so that the current is restrained from concentrating on a specific contact plug, thereby restraining electromigration in the contact plugs b1, b2, b3, and b4.

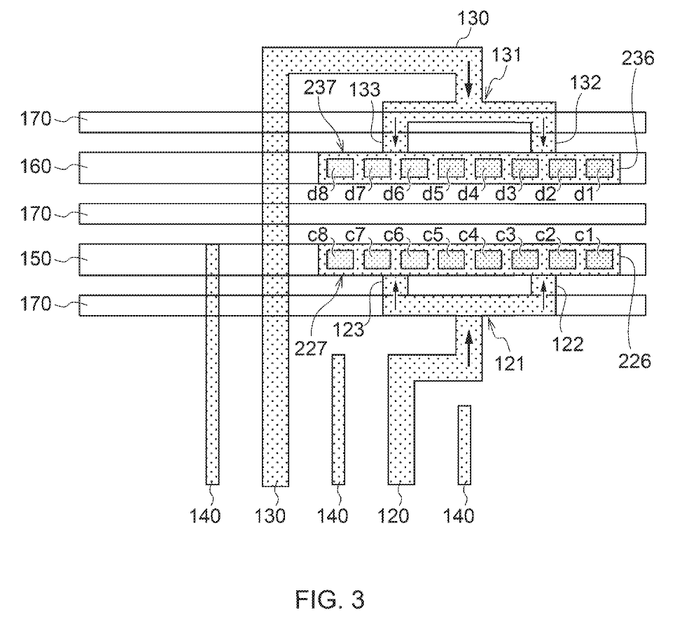

FIG. 3 is a diagram showing a schematic configuration of a semiconductor device according to a second embodiment, and is a layout diagram showing an example of a schematic configuration of wiring connection at a connection portion Y or Z shown in FIG. 5. The second embodiment discloses an aspect in a case where the number of contact plugs for connecting the clock signal trunk line and the clock driver signal line is eight.

The connection wiring 226 and the first clock signal trunk line 150 are connected to each other by eight contact plugs c1, c2, c3, c4, c5, c6, c7, and c8. The contact plugs c1, c2, c3, c4, c5, c6, c7, and c8 are arranged in order along the extension direction of the first clock signal trunk line 150 and the connection wiring 226. The contact plugs c1, c2, c3, c4, c5, c6, c7, and c8 are arranged at equal intervals.

The length of the connection wiring 226 is set to be longer than the length of the connection wiring 126 of the first embodiment in accordance with the number of the contact plugs. The wiring segments 122 and 123 are connected to the connection wiring 226 such that current flows uniformly from the first clock driver signal line 120 into the contact plugs c1, c2, c3, c4, c5, c6, c7, and c8. In this case, the wiring segments 122 and 123 are connected to the connection wiring 226 at a portion between the adjacent contact plugs c2 and c3 and at a portion between the adjacent contact plugs c6 and c7, respectively.

The eight contact plugs c1, c2, c3, c4, c5, c6, c7, and c8 are divided into groups such that the numbers of contact plugs of the groups are the same. Here, the contact plugs c1, c2, c3, c4, c5, c6, c7, and c8 are divided into groups each including four contact plugs, that is, a fifth group including the contact plugs c1, c2, c3, and c4, and a sixth group including the contact plugs c5, c6, c7, and c8. The wiring segment 122 is associated with the fifth group, and connected to the connection wiring 226 at the portion between the contact plugs c2 and c3 located at the center of the fifth group. The wiring segment 123 is associated with the sixth group, and connected to the connection wiring 226 at the portion between the contact plugs c6 and c7 located at the center of the sixth group.

The connection wiring 236 and the second clock signal trunk line 160 are connected to each other by eight contact plugs d1, d2, d3, d4, d5, d6, d7, and d8. The contact plugs d1, d2, d3, d4, d5, d6, d7, and d8 are arranged in order along the extension direction of the second clock signal trunk line 160 and the connection wiring 236. The contact plugs d1, d2, d3, d4, d5, d6, d7, and d8 are arranged at equal intervals.

The length of the connection wiring 236 is set to be longer than the length of the connection wiring 136 of the first embodiment in accordance with the number of the contact plugs. The wiring segments 132 and 133 are connected to the connection wiring 236 such that current flows uniformly from the second clock driver signal line 130 into the contact plugs d1, d2, d3, d4, d5, d6, d7, and d8. In this case, the wiring segments 132 and 133 are connected to the connection wiring 236 at a portion between the adjacent contact plugs d2 and d3, and at a portion between the adjacent contact plugs d6 and d7, respectively.

The eight contact plugs d1, d2, d3, d4, d5, d6, d7, and d8 are divided into groups such that the numbers of contact plugs of the groups are the same. Here, the contact plugs d1, d2, d3, d4, d5, d6, d7, and d8 are divided into groups each including four contact plugs, that is, a seventh group including the contact plugs d1, d2, d3, and d4, and an eighth group including the contact plugs d5, d6, d7, and d8. The wiring segment 132 is associated with the seventh group, and connected to the connection wiring 236 at the portion between the contact plugs d2 and d3 located at the center of the seventh group. The wiring segment 133 is associated with the eighth group, and connected to the connection wiring 236 at the portion between the contact plugs d6 and d7 located at the center of the eighth group.

The contact plugs c1, c2, c3, c4, c5, c6, c7, and c8, and the contact plugs d1, d2, d3, d4, d5, d6, d7, and d8 include a conductive material, and for example, include a metal such as tungsten, copper, or titanium nitride, or a metal compound thereof.

As described above, the first clock driver signal line 120 branches into the wiring segments 122 and 123, and the branched wiring segments 122 and 123 are further connected to the connection wiring 226 while uniformly dispersed in the manner described above. In this way, the wiring segments 122 and 123 are connected to the connection wiring 226 while uniformly dispersed. As a result, the current flowing from the first clock driver signal line 120 is dispersively distributed to the contact plugs c1, c2, c3, c4, c5, c6, c7, and c8, so that the current is restrained from concentrating on a specific contact plug. As a result, electromigration in the contact plugs c1, c2, c3, c4, c5, c6, c7, and c8 is restrained.

Similarly, the second clock driver signal line 130 branches into wiring segments 132 and 133, and the branched wiring segments 132 and 133 are further connected to the connection wiring 236 while uniformly dispersed in the manner described above. As a result, the current flowing from the second clock driver signal line 130 is dispersively distributed to the contact plugs d1, d2, d3, d4, d5, d6, d7, and d8, so that the current is restrained from concentrating on a specific contact plug. Therefore, electromigration in the contact plugs d1, d2, d3, d4, d5,d6, d7, and d8 is restrained. The other configurations are the same as those of the first embodiment.

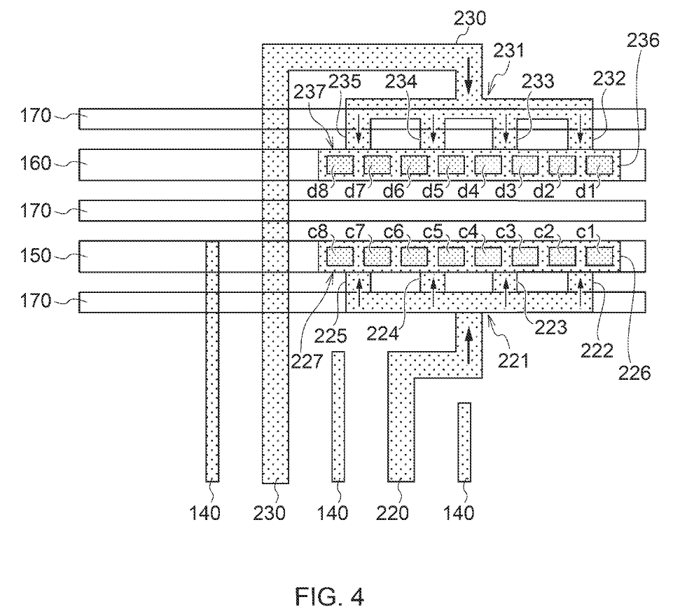

FIG. 4 is a diagram showing a schematic configuration of a semiconductor device according to a third embodiment, and is a layout diagram showing an example of a schematic configuration of wiring connection at a connection portion Y or Z shown in FIG. 5. The third embodiment further discloses an aspect in which the clock signal trunk line branches into four wiring segments.

The third clock driver signal line 220 and the fourth clock driver signal line 230 correspond to wirings for connecting the clock driver 310 or 311 to the clock signal trunk line 300 or 301. The first clock signal trunk line 150 and the second clock signal trunk line 160 correspond to either the clock signal trunk line 300 or 301.

The third clock driver signal line 220 and the fourth clock driver signal line 230 are included in conductive wirings of a first layer. The first clock signal trunk line 150 and the second clock signal trunk line 160 are included in conductive wirings of a second layer which is a layer different from the first layer.

The third clock driver signal line 220 branches into four wiring segments 222, 223, 224, and 225 at a branching portion 221. The wiring segments 222, 223, 224, and 225 are arranged at equal intervals. Each of the wiring segments 222, 223, 224, and 225 is connected to a connection wiring 226. The third clock driver signal line 220, the wiring segments 222, 223, 224, and 225, and the connection wiring 226 are included in the first layer. The connection wiring 226 is connected to the first clock signal trunk line 150 via contact plugs c1, c2, c3, c4, c5, c6, c7, and c8. In this case, the connection wiring 226 and the first clock signal trunk line 150 are connected to each other by the eight contact plugs c1, c2, c3, c4, c5, c6, c7, and c8.

The wiring segments 222, 223, 224, and 225 are connected to the connection wiring 226 such that current flows uniformly from the third clock driver signal line 220 into the contact plugs c1, c2, c3, c4, c5, c6, c7, and c8. In this case, the wiring segments 222, 223, 224, and 225 are connected to the connection wiring 226 at a portion between the adjacent contact plugs c1 and c2, at a portion between the adjacent contact plugs c3 and c4, at a portion between the adjacent contact plugs c5 and c6, and at a portion between the adjacent contact plugs c7 and c8, respectively.

The eight contact plugs c1, c2, c3, c4, c5, c6, c7, and c8 are divided into groups such that the numbers of contact plugs of the groups are the same. In this case, the contact plugs c1, c2, c3, c4, c5, c6, c7, and c8 are divided into groups each including two contact plugs, that is, a ninth group including the contact plugs c1 and c2, a tenth group including the contact plugs c3 and c4, an eleventh group including the contact plugs c5 and c6, and a twelfth group including the contact plugs c7 and c8.

The wiring segment 222 is associated with the ninth group, and is connected to the connection wiring 226 at a portion between the contact plugs c1 and c2 located at the center of the 9th group. The wiring segment 223 is associated with the tenth group, and is connected to the connection wiring 226 at a portion between the contact plugs c3 and c4 located at the center of the 10th group. The wiring segment 224 is associated with the eleventh group, and is connected to the connection wiring 226 at a portion between the contact plugs c5 and c6 located at the center of the 11th group. The wiring segment 225 is associated with the twelfth group, and is connected to the connection wiring 226 at a portion between the contact plugs c7 and c8 located at the center of the twelfth group.

Similarly, the fourth clock driver signal line 230 branches into four wiring segments 232, 233, 234, and 235 at a branching portion 231. The wiring segments 232, 233, 234, and 235 are arranged at equal intervals. Each of the wiring segments 232, 233, 234, and 235 is connected to a connection wiring 236. The fourth clock driver signal line 230, the wiring segments 232, 233, 234, and 235, and the connection wiring 236 are included in a first layer. The connection wiring 236 is connected to the second clock signal trunk line 160 via contact plugs d1, d2, d3, d4, d5, d6, d7, and d8. In this case, the connection wiring 236 and the second clock signal trunk line 160 are connected to each other by the eight contact plugs d1, d2, d3, d4, d5, d6, d7, and d8.

The wiring segments 232, 233, 234, and 235 are connected to the connection wiring 236 such that current flows uniformly from the fourth clock driver signal line 230 into the contact plugs d1, d2, d3, d4, d5, d6, d7, and d8. In this case, the wiring segments 232, 233, 234, and 235 are connected to the connection wiring 236 at a portion between the adjacent contact plugs d1 and d2, at a portion between the adjacent contact plugs d3 and d4, at a portion between the adjacent contact plugs d5 and d6, and at a portion between adjacent contact plugs d7 and d8, respectively.

The contact plugs d1, d2, d3, d4, d5, d6, d7, and d8 are divided into groups such that the numbers of the contact plugs of the groups are the same. In this case, the contact plugs d1, d2, d3, d4, d5, d6, d7, and d8 are divided into groups each including two contact plugs, that is, a thirteenth group including the contact plugs d1 and d2, a fourteenth group including the contact plugs d3 and d4, a fifteenth group including the contact plugs d5 and d6, and a sixteenth group including the contact plugs d7 and d8.

The wiring segment 232 is associated with the thirteenth group, and connected to the connection wiring 236 at a portion between the contact plugs d1 and d2 located at the center of the thirteenth group. The wiring segment 233 is associated with the fourteenth group, and connected to the connection wiring 236 at a portion between the contact plugs d3 and d4 located at the center of the fourteenth group. The wiring segment 234 is associated with the fifteenth group, and connected to the connection wiring 236 at a portion between the contact plugs d5 and d6 located at the center of the fifteenth group. The wiring segment 235 is associated with the sixteenth group, and connected to the connection wiring 236 at a portion between the contact plugs d7 and d8 located at the center of the 16th group.

The third clock driver signal line 220, the fourth clock driver signal line 230, the contact plugs c1, c2, c3, c4, c5, c6, c7, c8, and the contact plugs d1, d2, d3, d4, d5, d6, d7, d8 contain a conductive material, and for example, include metal such as tungsten, copper, or titanium nitride, or a metal compound thereof.

As described above, the third clock driver signal line 220 branches into the wiring segments 222, 223, 224, and 225, and the branched wiring segments 222, 223, 224, and 225 are connected to the connection wiring 226 while uniformly dispersed in the manner described above. As a result, current flows dispersively from the third clock driver signal line 220 into the contact plugs c1, c2, c3, c4, c5, c6, c7, and c8, so that the current is restrained from concentrating on a specific contact plug. Therefore, electromigration in the contact plugs c1, c2, c3, c4, c5, c6, c7, and c8 is restrained.

Similarly, the fourth clock driver signal line 230 branches into wiring segments 232, 233, 234, and 235, and the branched wiring segments 232, 233, 234, and 235 are further connected to the connection wiring 236 while uniformly dispersively distributed in the manner described above. As a result, current dispersively flows from the fourth clock driver signal line 230 into the contact plugs d1, d2, d3, d4, d5, d6, d7, and d8, so that the current is restrained from concentrating on a specific contact plug. Therefore, electromigration in the contact plugs d1, d2, d3, d4, d5, d6, d7, and d8 is restrained.

The semiconductor devices according to the first, second and third embodiments have been described while applying a case where the clock driver signal lines 120, 130, 220, 230 included in the first layer are set in a lower layer, and the clock signal trunk lines 150, 160 included in the second layer are set in an upper layer located above the first layer, but these embodiments are not limited to this configuration. The clock driver signal lines 120, 130, 220, 230 included in the first layer may be set in an upper layer, and the clock signal trunk lines 150, 160 included in the second layer may be set in a lower layer located below the first layer.

The first and second embodiments disclose an aspect in which each of the clock driver signal line branches into two or four wiring segments, but this aspect is merely an example, and the number of wiring segments to be branched is not limited to a specific number. The clock driver signal line may branch into three or five or more wiring segments.

Furthermore, the number of contact plugs for connecting the clock driver signal line and the signal trunk line is not limited to the number disclosed in the embodiments. The number of contact plugs may be three or may be further increased. Furthermore, when there is an area margin for arranging the connection wirings longer, the number of branches of the clock driver signal line can be increased according to the number of contact plugs and the lengths of the connection wirings, which allows the current flowing through the contact plugs to be dispersively distributed.

DRAM has been described as an application example of the embodiments. However, although not limited, examples of devices to be applicable include a static random access memory (SRAM), a phase change random access memory (PRAM), a resistive random access memory (RRAM), a magneto-resistive random access memory (MRAM), a ferroelectric random access memory (FeRAM), a spin transfer torque random access memory (STT-RAM), a flash memory, etc. Furthermore, the embodiments have been described by exemplifying the configuration of the connection portion between the clock signal trunk line and the clock driver signal line, but they are not intended to be limited to the aspect disclosed herein, and may be applied to connection portions between signal trunk lines and signal lines that transmit a command signal, an address signal, a data signal, a data strobe signal, and other signals.

As above, DRAM is described as an example of the semiconductor device according to the embodiment, but the above description is merely one example and not intended to be limited to DRAM. Memory devices other than DRAM, such as static random-access memory (SRAM), flash memory, erasable programmable read-only memory (EPROM), magnetoresistive random-access memory (MRAM), and phase-change memory for example can also be applied as the semiconductor device. Furthermore, devices other than memory, including logic ICs such as a microprocessor and an application-specific integrated circuit (ASIC), for example, are also applicable as the semiconductor device according to the foregoing embodiment.

Although various embodiments have been disclosed in the context of certain preferred embodiments and examples, it will be understood by those skilled in the art that the scope of the present disclosure extends beyond the specifically disclosed embodiments to other alternative embodiments and/or uses of the embodiments and obvious modifications and equivalents thereof. In addition, other modifications which are within the scope of this disclosure will be readily apparent to those of skill in the art based on this disclosure. It is also contemplated that various combination or sub-combination of the specific features and aspects of the embodiments may be made and still fall within the scope of the disclosure. It should be understood that various features and aspects of the disclosed embodiments can be combined with or substituted for one another in order to form varying modes of the disclosed embodiments. Thus, it is intended that the scope of at least some of the present disclosure should not be limited by the particular disclosed embodiments described above.

1. An apparatus comprising:
a first wiring in one of lower and upper wiring layers;
a second wiring in the other of the lower and upper wiring layers, the second wiring extending in parallel to the first wiring;
a plurality of contact plugs coupled between the first wiring and the second wiring and arranged in line along the first wiring and the second wiring; and
a third wiring in the one of the lower and upper wiring layers, the third wiring being branched into a plurality of wiring segments which are directly coupled to the first wiring.

2. The apparatus of claim 1, wherein the first wiring is a local electrode having an island shape.

3. The apparatus of claim 1, wherein at least one of the wiring segments of the third wiring is coupled to a portion of the first wiring between two of the plurality of contact plugs arranged adjacently.

4. The apparatus of claim 1, wherein the wiring segments of the third wiring are arranged at equal intervals.

5. The apparatus of claim 1, wherein the plurality of contact plugs includes first, second, third and fourth contact plugs arranged in line in numerical order;
wherein the first wiring and the third wiring are in the lower wiring layer and the second wiring is in the upper wiring layer; and
wherein the third wiring is branched, at least in part, into a first wiring segment coupled to a portion of the first wiring between the first and second contact plugs and a second wiring segment coupled to another portion of the first wiring between the third and fourth contact plugs.

6. The apparatus of claim 5, wherein the first wiring is a local electrode having an island shape.

7. The apparatus of claim 5, wherein the plurality of contact plugs are arranged at equal intervals.

8. The apparatus of claim 5, wherein the first wiring segment extends in parallel to the second wiring segment.

9. An apparatus comprising:
a first wiring in a lower wiring layer;
a second wiring in an upper wiring layer, extending in parallel to the first wiring;
a plurality of contact plugs coupled between the first wiring and the second wiring and arranged in line along the first wiring and the second wiring; and
a third wiring in the lower wiring layer, being branched into a plurality of wiring segments which are directly coupled to the first wiring.

10. The apparatus of claim 9, wherein the first wiring is a local electrode having an island shape.

11. The apparatus of claim 9, wherein at least one of the wiring segments of the third wiring is coupled to a portion of the first wiring between two of the plurality of contact plugs arranged adjacently.

12. The apparatus of claim 9, wherein the wiring segments of the third wiring are arranged at equal intervals.

13. The apparatus of claim 9, wherein the plurality of contact plugs includes first, second, third and fourth contact plugs arranged in line in numerical order; and
wherein the third wiring is branched, at least in part, into a first wiring segment coupled to a portion of the first wiring between the first and second contact plugs and a second wiring segment coupled to another portion of the first wiring between the third and fourth contact plugs.

14. The apparatus of claim 13, wherein the first wiring is a local electrode having an island shape.

15. An apparatus comprising:
a first wiring in a first wiring layer;
a second wiring in a second wiring layer arranged above or below the first wiring layer and extending in parallel to the first wiring;
a plurality of groups, each of the groups having a plurality of contact plugs coupled between the first wiring and the second wiring and arranged in line along the first wiring and the second wiring; and
a third wiring in the first wiring layer, being branched into a plurality of wiring segments;
wherein each wiring segment is directly coupled to a portion of the first wiring corresponding to one of the groups associated with each of the wiring segments.

16. The apparatus of claim 15, wherein the first wiring is a local electrode having an island shape.

17. The apparatus of claim 15, wherein the each wiring segment is directly coupled to a portion of the first wiring at a center of the corresponding group between two contact plugs.

18. The apparatus of claim 15, wherein the wiring segments of the third wiring are arranged at equal intervals.

19. The apparatus of claim 15, wherein each of the groups includes first, second, third and fourth contact plugs arranged in line in numerical order: and
wherein at least one of the wiring segments is coupled to a portion of the first wiring between the second contact plug and the third contact plug of a corresponding group.

20. The apparatus of claim 15, wherein each of the groups includes first and second contact plugs arranged in line in numerical order: and
wherein at least one of the wiring segments is coupled to a portion of the first wiring between the first contact plug and the second contact plug of a corresponding group.
